(19) United States
(12) Patent Application Publication
(10) Pub. No.: US 2026/0203076 A1
(43) Pub. Date: Jul. 16, 2026

(54) GENERATION AND IMPLEMENTATION OF ARTIFICIAL INTELLIGENCE (AI) AGENT PERSONAS FOR TASK EXECUTION

(71) Applicant: Ally Financial Inc., Detroit, MI (US)

(72) Inventors: Harish NAIK, Phoenix, AZ (US); Dzmitry DUBARAU, Charlotte, NC (US); Arvy RAJASEKARAN, Charlotte, NC (US); Jared ALLMOND, Detroit, MI (US); Daniel LEMONT, Detroit, MI (US); Andrew SWISTAK, Charlotte, NC (US); Sathish MUTHUKRISHNAN, Charlotte, NC (US)

(21) Appl. No.: 19/020,373

(22) Filed: Jan. 14, 2025

(51) Int. Cl. G06F 9/445; G06F 40/30

(52) U.S. Cl. CPC G06F 9/4451; G06F 40/30

(57) ABSTRACT

Methods, systems, and devices for artificial intelligence (AI) agent configuration are described. An AI agent flow may obtain a prompt that includes a request to execute one or more tasks that invoke use of one or more AI agents, where each AI agent may be configured to exhibit one or more characteristics of a user. The AI agent flow may determine the intent and domain of the prompt, a quantity or type of AI agents invoked for the prompt, along with respective configurations of the one or more AI agents. The AI agent flow may then obtain, via one or more data stores or via execution of one or more algorithms, a set of characteristics of the one or more AI agents. The AI agent flow may then obtain one or more outputs that satisfy the prompt via at least one workflow executed by the one or more AI agents.

### FIELD OF TECHNOLOGY

The present disclosure relates generally to data management, including techniques for generation and implementation of artificial intelligence (AI) agent personas for task execution.

### BACKGROUND

An organization (e.g., a company, a corporation, a financial institution, or the like) may utilize multiple forms of communications to maintain multiple projects and support the success of the organization. For example, representatives of the organization may participate in meetings to discuss the status of projects, delegate tasks associated with projects, discuss and decide on various updates to projects, and so on. Additionally, a representative of an organization may communicate with a customer, for example, to discuss updates or other changes to a customer's account. In some cases, the organization may utilize different strategies to address the needs of different customers. For example, different demographics may have different interests and goals, and an organization may need to implement customized strategies to satisfy such customers (e.g., based on behavioral trends, based on behaviors typically exhibited by some groups of people, among other examples). On a more granular level, respective individuals may behave uniquely in various situations and interactions, and an organization may need to predict and anticipate such behaviors to provide an improved experience for these customers.

### SUMMARY

The systems, methods, and devices of this disclosure each have several innovative aspects, no single one of which is solely responsible for the desirable attributes disclosed herein.

A method by an apparatus is described. The method may include obtaining a prompt that includes a request to execute one or more tasks that invoke use of one or more artificial intelligence (AI) agents, where each AI agent of the one or more AI agents are configured to exhibit one or more characteristics of a user, determining, in accordance with the request, at least one of an intent of the prompt, a domain of the prompt, a quantity of AI agents invoked for the prompt, or one or more different types of AI agents invoked for the prompt, obtaining respective configurations of the one or more AI agents based on an evaluation of the prompt, obtaining, via one or more data stores or via execution of one or more algorithms, a set of characteristics of the one or more AI agents in accordance with the respective configurations, and obtaining one or more outputs that satisfy the prompt in accordance with at least one workflow executed by the one or more AI agents.

An apparatus is described. The apparatus may include one or more memories storing processor executable code, and one or more processors coupled with the one or more memories. The one or more processors may individually or collectively be operable to execute the code to cause the apparatus to obtain a prompt that includes a request to execute one or more tasks that invoke use of one or more AI agents, where each AI agent of the one or more AI agents are configured to exhibit one or more characteristics of a user, determine, in accordance with the request, at least one of an intent of the prompt, a domain of the prompt, a quantity of AI agents invoked for the prompt, or one or more different types of AI agents invoked for the prompt, obtain respective configurations of the one or more AI agents based on an evaluation of the prompt, obtain, via one or more data stores or via execution of one or more algorithms, a set of characteristics of the one or more AI agents in accordance with the respective configurations, and obtain one or more outputs that satisfy the prompt in accordance with at least one workflow executed by the one or more AI agents.

Another apparatus is described. The apparatus may include means for obtaining a prompt that includes a request to execute one or more tasks that invoke use of one or more AI agents, where each AI agent of the one or more AI agents are configured to exhibit one or more characteristics of a user, means for determining, in accordance with the request, at least one of an intent of the prompt, a domain of the prompt, a quantity of AI agents invoked for the prompt, or one or more different types of AI agents invoked for the prompt, means for obtaining respective configurations of the one or more AI agents based on an evaluation of the prompt, means for obtaining, via one or more data stores or via execution of one or more algorithms, a set of characteristics of the one or more AI agents in accordance with the respective configurations, and means for obtaining one or more outputs that satisfy the prompt in accordance with at least one workflow executed by the one or more AI agents.

A non-transitory computer-readable medium storing code is described. The code may include instructions executable by one or more processors to obtain a prompt that includes a request to execute one or more tasks that invoke use of one or more AI agents, where each AI agent of the one or more AI agents are configured to exhibit one or more characteristics of a user, determine, in accordance with the request, at least one of an intent of the prompt, a domain of the prompt, a quantity of AI agents invoked for the prompt, or one or more different types of AI agents invoked for the prompt, obtain respective configurations of the one or more AI agents based on an evaluation of the prompt, obtain, via one or more data stores or via execution of one or more algorithms, a set of characteristics of the one or more AI agents in accordance with the respective configurations, and obtain one or more outputs that satisfy the prompt in accordance with at least one workflow executed by the one or more AI agents.

Some examples of the method, apparatus, and non-transitory computer-readable medium described herein may further include operations, features, means, or instructions for obtaining an evaluation score associated with the one or more outputs, where the evaluation score may be indicative of an effectiveness of the one or more AI agents in execution of the prompt.

Some examples of the method, apparatus, and non-transitory computer-readable medium described herein may further include operations, features, means, or instructions for storing the evaluation score in a database, where the evaluation score includes a binary evaluation representative of a positive evaluation, a negative evaluation, a numerical score, a numerical percentage, one or more quantitative metrics, or any combination thereof.

Some examples of the method, apparatus, and non-transitory computer-readable medium described herein may further include operations, features, means, or instructions for applying feedback associated with the evaluation score in accordance with one or more feedback loops, where application of the feedback includes modifying the one or more AI agents based on the feedback.

In some examples of the method, apparatus, and non-transitory computer-readable medium described herein, determining the intent of the prompt may include operations, features, means, or instructions for identifying the request associated with the prompt, where the request includes creation of content, summarization of content, evaluation of content, interaction with content, or any combination thereof.

In some examples of the method, apparatus, and non-transitory computer-readable medium described herein, determining the domain of the prompt may include operations, features, means, or instructions for determining the domain of the prompt based on parameter information of the user, application metadata, or both.

In some examples of the method, apparatus, and non-transitory computer-readable medium described herein, determining the quantity of AI agents invoked for the prompt may include operations, features, means, or instructions for obtaining a message including an indication of the quantity of AI agents invoked for the prompt, determining the quantity of AI agents may be based on obtaining the indication.

In some examples of the method, apparatus, and non-transitory computer-readable medium described herein, obtaining the respective configurations of the one or more AI agents may include operations, features, means, or instructions for selecting the respective configurations of the one or more AI agents from a set of initial configurations, where the set of initial configurations may be based on one or more training datasets.

In some examples of the method, apparatus, and non-transitory computer-readable medium described herein, obtaining the respective configurations of the one or more AI agents may include operations, features, means, or instructions for selecting the respective configurations of the one or more AI agents from a set of configurations and obtaining one or more updates to the respective configurations based on the respective configurations failing to satisfy an agent performance threshold for the one or more AI agents.

Some examples of the method, apparatus, and non-transitory computer-readable medium described herein may further include operations, features, means, or instructions for determining that a set of available configurations fail to satisfy the prompt, where obtaining the respective configurations of the one or more AI agents includes and assigning a default configuration to the prompt, where obtaining the one or more outputs satisfying the prompt may be based on the default configuration.

Some examples of the method, apparatus, and non-transitory computer-readable medium described herein may further include operations, features, means, or instructions for matching the prompt to an existing process template after the prompt may be completed and generating an additional process template after the prompt may be completed.

In some examples of the method, apparatus, and non-transitory computer-readable medium described herein, the set of characteristics of the one or more AI agents may be based on demographic data, geographic data, application interaction data, engagement data, behavioral data, psychographic data, or any combination thereof.

In some examples of the method, apparatus, and non-transitory computer-readable medium described herein, the one or more algorithms include a k-nearest neighbors (KNN) algorithm, a k-means algorithm, a machine learning algorithm, or any combination thereof.

In some examples of the method, apparatus, and non-transitory computer-readable medium described herein, the prompt may be submitted by at least one of an external source, the user, or an application.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates an example of a computing environment that supports generation and implementation of artificial intelligence (AI) agent personas for task execution in accordance with aspects of the present disclosure.

FIG. 2 shows an example of an AI agent configuration and execution framework that supports generation and implementation of AI agent personas for task execution in accordance with aspects of the present disclosure.

FIG. 3 shows an example of a process flow that supports generation and implementation of AI agent personas for task execution in accordance with aspects of the present disclosure.

FIG. 4 shows a block diagram of a system that supports generation and implementation of AI agent personas for task execution in accordance with aspects of the present disclosure.

FIG. 5 shows a block diagram of an AI agent configuration and execution component that supports generation and implementation of AI agent personas for task execution in accordance with aspects of the present disclosure.

FIG. 6 shows a diagram of a system including a device that supports generation and implementation of AI agent personas for task execution in accordance with aspects of the present disclosure.

FIGS. 7 and 8 show flowcharts illustrating methods that support generation and implementation of AI agent personas for task execution in accordance with aspects of the present disclosure.

### DETAILED DESCRIPTION

An organization (e.g., a company, a corporation, a financial institution, or the like) may employ artificial intelligence (AI) systems that allows the organization to build and invoke different AI agents for execution of different tasks. In some aspects, an AI agent may be generated and trained using different AI techniques such as machine learning and natural language processing (NLP) to handle a wide range of tasks. Such AI agents may perform tasks such as decision-making, problem-solving, interacting with external environments and executing actions such as answering simple questions to resolving complex issues, generating content, and emulating a user or customer. In some aspects, AI agents may also continuously improve their own performance through self-learning.

In some implementations, an organization may utilize AI agents to execute one or more tasks related to a prompt. In such cases, techniques may be utilized to dynamically identify and integrate one or more different AI agents for executing a workflow. In order to effectively identify a suitable AI agent, an AI agent workflow may include various steps in order to generate unique AI agent personas to execute the one or more tasks. For example, the AI agent workflow may evaluate the prompt to determine one or more AI agents to be invoked for the one or more tasks. The AI agent workflow may then access a persona store that includes a set of different AI agent personas (e.g., including different personality traits of a customer, demographic data, psychographic data, among other characteristics of a customer), and may select an AI agent persona to deploy for the one or more tasks. In some examples, the different AI agent persona may be created and/or accessed dynamically, to generate an AI agent that is most suitable for performing the one or more tasks. After generating or selecting the AI agent, an agentic workflow may be executed to complete the one or more tasks and produce an output, and a grade may be assigned and stored for the AI agent and the output.

The dynamic creation and application of AI agents may support various different use cases. For example, a company may generate and deploy an AI agent that emulates a person of a specific group (e.g., a Gen-Z, a Millennial, a Boomer) to create different application content or written articles to best appeal to actual customers that are of the same specific group that the AI agent emulates. Additionally, or alternatively, an organization may dynamically generate different AI agents for training purposes. For example, the organization (or an employee of the organization) may invoke the use of an AI agent that emulates a dissatisfied customer, so that an employee may practice a customer service interaction with the AI agent in real time. Additionally, or alternatively, an AI agent may be invoked as a chat bot that has similar language use and style as a customer using the chat bot.

Aspects of the disclosure may be implemented to realize one or more of the following potential advantages. In some examples, the dynamic deployment of AI agents may support automation of routine tasks (e.g., testing and reviews), which may reduce time costs for a human employee. The dynamic deployment of AI agents may also be highly scalable, as the total quantity and/or type of AI agents invoked for a task may be easily changed or modified in order to cater to different application needs. Additionally, or alternatively, the implementation of AI agents may reduce cost (e.g., AI agents may help carry out activities that are otherwise impossible or not practically possible, or otherwise would be cost prohibitive). Additionally, or alternatively, the techniques described herein may allow for continuous change and learning for each AI agent persona generated. For example, the characteristics of each AI agent may be statistically or dynamically modified to cater to a specific prompt, and new AI agents may be created based on evaluation of various datasets.

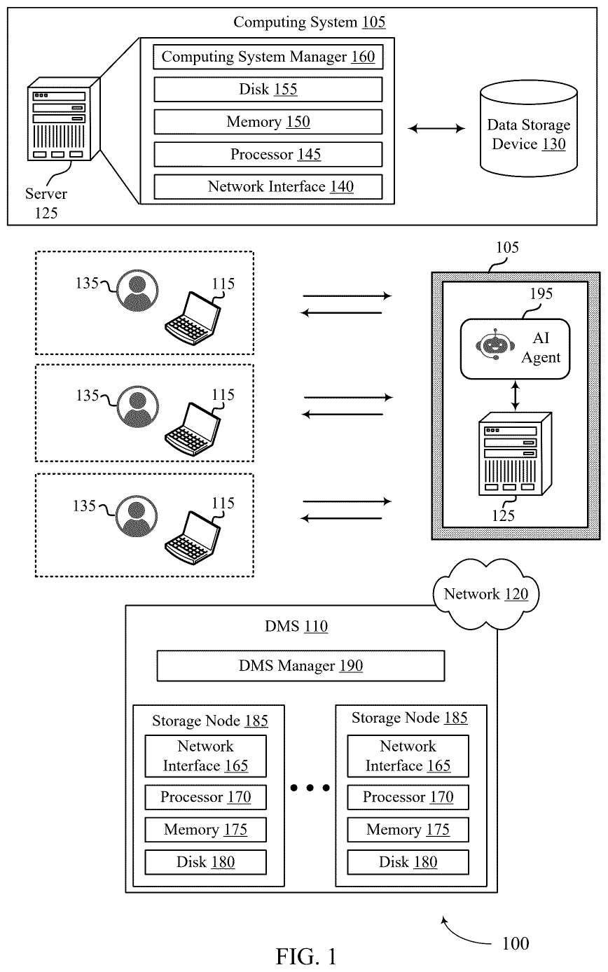

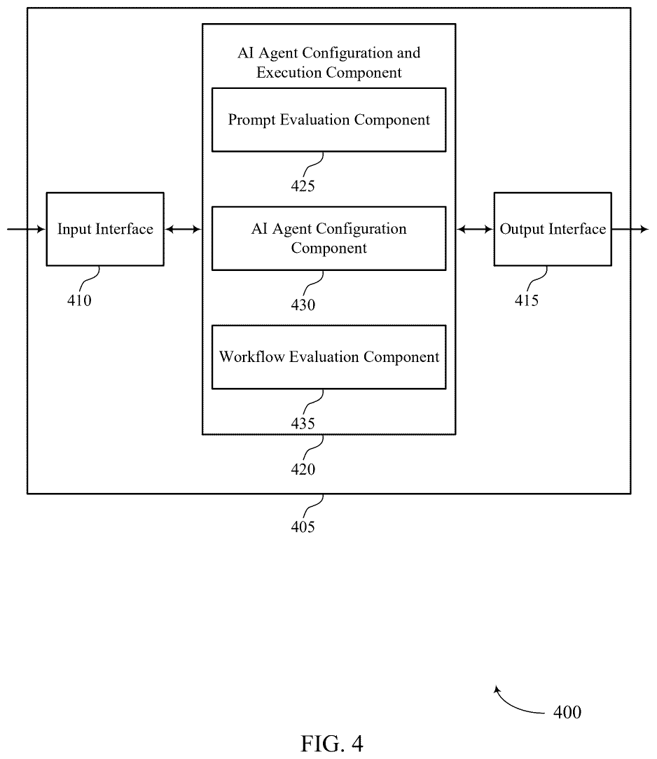

Aspects of the disclosure are initially described in the context of systems, AI agent configuration and execution frameworks, and process flows with reference to FIGS. 1 through 3. Aspects of the disclosure are further illustrated by and described with reference to systems and flowcharts that relate to techniques for verifying a sender identity using a user-generated identifier with reference to FIGS. 4 through 8.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a system to additionally, or alternatively, solve other problems than those described herein. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

FIG. 1 illustrates an example of a computing environment 100 that supports generation and implementation of AI agent personas for task execution in accordance with aspects of the present disclosure. The computing environment 100 may include a AI-integrated computing system 105, a data management system (DMS) 110, and one or more computing devices 115, which may be in communication with one another via a network 120. The AI-integrated computing system 105 may generate, store, process, modify, or otherwise use associated data, and the DMS 110 may provide one or more data management services for the AI-integrated computing system 105. For example, the DMS 110 may provide a data backup service, a data recovery service, a data classification service, a data transfer or replication service, one or more other data management services, or any combination thereof for data associated with the AI-integrated computing system 105.

The network 120 may allow the one or more computing devices 115, the AI-integrated computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the AI-integrated computing system 105, the DMS 110, or both. For example, a user of the computing device 115 may provide user inputs via the computing device 115, which may result in commands, data, or any combination thereof being communicated via the network 120 to the AI-integrated computing system 105, the DMS 110, or both. Additionally, or alternatively, a computing device 115 may output (e.g., display) data or other information received from the AI-integrated computing system 105, the DMS 110, or both. A user of a computing device 115 may, for example, use the computing device 115 to interact with one or more user interfaces (e.g., graphical user interfaces (GUIs)) to operate or otherwise interact with the AI-integrated computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the AI-integrated computing system 105 or the DMS 110.

The AI-integrated computing system 105 may include one or more servers 125 and may provide (e.g., to the one or more computing devices 115) local or remote access to applications, databases, or files stored within the AI-integrated computing system 105. The AI-integrated computing system 105 may further include one or more data storage devices 130. Though one server 125 and one data storage device 130 are shown in FIG. 1, it is to be understood that the AI-integrated computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the AI-integrated computing system 105, to upload such information or files to the AI-integrated computing system 105, or to perform a search query related to particular information stored by the AI-integrated computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the AI-integrated computing system 105 or aspects thereof (e.g., based on instructions stored in the memory 150 and executed by the processor 145) to perform functions ascribed herein to the AI-integrated computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the AI-integrated computing system 105.

In some examples, the AI-integrated computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the AI-integrated computing system 105 or aspects thereof through Software-as-a-Service (SaaS) or Infrastructureas-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the AI-integrated computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the AI-integrated computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the AI-integrated computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the AI-integrated computing system 105 but in communication with the AI-integrated computing system 105 via the network 120) It is to be understood, however, that in some examples at least some aspects of the DMS 110 may be located within AI-integrated computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

In some examples, the DMS 110 may provide a data classification service, a malware detection service, a data transfer or replication service, backup verification service, or any combination thereof, among other possible data management services for data associated with the AI-integrated computing system 105. For example, the DMS 110 may analyze data included in one or more computing objects of the AI-integrated computing system 105, metadata for one or more computing objects of the AI-integrated computing system 105, or any combination thereof, and based on such analysis, the DMS 110 may identify locations within the AI-integrated computing system 105 that include data of one or more target data types (e.g., sensitive data, such as data subject to privacy regulations or otherwise of particular interest) and output related information (e.g., for display to a user via a computing device 115).

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the AI-integrated computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data to a cloud environment (e.g., Microsoft Azure or Amazon Web Services). In addition, or as an alternative, to being configured to manage the transfer of data management data to the cloud environment, the control plane may be configured to transfer metadata for the data management data to the cloud environment. The metadata may be configured to facilitate storage of the stored data management data, the management of the stored management data, the processing of the stored management data, the restoration of the stored data management data, and the like.

One or more users 135 may interact (e.g., via computing devices 115) with the AI-integrated computing system 105 using an interface, which may support communications between a computing device 115 and the AI-integrated computing system 105. For example, the interface may allow the computing device 115 to transmit one or more messages (e.g., via the network) to the AI-integrated computing system 105, and may allow the AI-integrated computing system 105 to transmit one or more messages to the computing device 115. In some examples, the interface may provide one or more prompts to the computing device 115, and may allow the user 135 to enter information as a response to the prompts.

For example, a computing device 115 may provide, via the interface, a data set to the AI-integrated computing system 105. The AI-integrated computing system 105 may include an AI agent 195 operable to process the data set to identify one or more tasks associated with one or more projects using the data set. For example, the AI agent 195 may include or may interface with a large language model (LLM). The AI agent 195 may provide the data set to the LLM (e.g., may input the data set to the LLM), and the LLM may process the data sets to identify one or more tasks associated with the data sets. An AI agent 195 may implement, utilize, or be associated with one or more ML algorithms, where an ML algorithm may be an example of a neural network, such as a feed forward (FF) or deep feed forward (DFF) neural network, a recurrent neural network (RNN), a long/short term memory (LSTM) neural network, or any other type of neural network. However, any other ML algorithms may be supported. For example, the ML algorithm may implement a nearest neighbor algorithm, a linear regression algorithm, a Naïve Bayes algorithm, a random forest algorithm, or any other ML algorithm. Further, ML processes associated with the AI agent 195 may involve supervised learning, unsupervised learning, semi-supervised learning, reinforcement learning, or any combination thereof. As described herein, an AI functionality or AI model may be referred to as an ML functionality or ML model, or vice versa. That is, the terms “AI” and “ML” may, in some examples, be used interchangeably to refer to similar technologies, models, functions, algorithms, or any combination thereof. Similarly, the terms “model” and “functionality” may be used interchangeably. In some examples, ML operations may be considered a subset of AI operations. In any case, aspects of the features described herein may be referred to as AI functionalities, AI functions, AI models, AI services, AI operations, or the like, and such features may be similarly applicable to ML functionalities, ML functions, ML models, ML services, ML operations, or any combination thereof. Thus, reference to “ML” or “AI” may refer to ML, AI, or both, and the terms “AI” or “ML” should not be considered limiting to the scope of the claims or the disclosure.

In some examples, the LLM may be an example of an ML system operable to receive one or more text inputs and generate a text output in response to the text inputs. The LLM may be an example of an artificial neural network and/or a deep learning algorithm, and the LLM may be used for various functions and operations including, for example, natural language processing, language generation, language summarization, and language prediction, to name a few. In some aspects, the LLM may utilize very large datasets (e.g., text data) and may be capable of comprehending human language text. The AI-integrated computing system 105 may configure the LLM to identify tasks associated with the data set, and may configure the LLM to output the tasks in accordance with a specified format. For example, the AI-integrated computing system 105 may configure the LLM to output a list or file that includes the one or more tasks, along with metadata associated with the tasks, such as a type of task for each of the tasks.

The AI agent 195 may select one or more software agents to execute each of the identified tasks. For example, the AI agent 195 may identify a respective type for each task, and may select a respective software agent of a set of supported software agents configured to execute the respective type of task. Each software agent may execute a respective task to produce an output, such as by generating a summary of a transcript, transmitting one or more communications to users 135 associated with the organization, or providing responses to inquiries, among other examples. By implementing the AI agent 195, the computing environment 100 may improve efficiency of projects of the organization, may improve accuracy and reliability of communications associated with projects of the organization, and may improve security of communications and updates associated with projects of the organization, among other benefits.

In some implementations, an organization may utilize AI agents 195 to execute one or more tasks related to a prompt. In such cases, techniques may be utilized to dynamically identify and integrate one or more different AI agents 195 for executing a workflow. In order to effectively identify a suitable AI agent 195, an AI agent workflow may include various steps in order to generate unique AI agent personas to execute the one or more tasks. For example, the AI agent workflow may evaluate the prompt to determine one or more AI agents 195 to be invoked for the one or more tasks. The AI agent workflow may then access a persona store that includes a set of different AI agent personas (e.g., including different personality traits of a customer, demographic data, psychographic data, among other characteristics of a customer), and may select an AI agent persona to deploy for the one or more tasks. In some examples, the different AI agent persona may be created and/or accessed dynamically, in order to generate an AI agent 195 that is most suitable for performing the one or more tasks. After generating or selecting the AI agent 195, an agentic workflow may be executed to complete the one or more tasks and produce an output, and a grade may be assigned and stored for the AI agent 195 and the output.

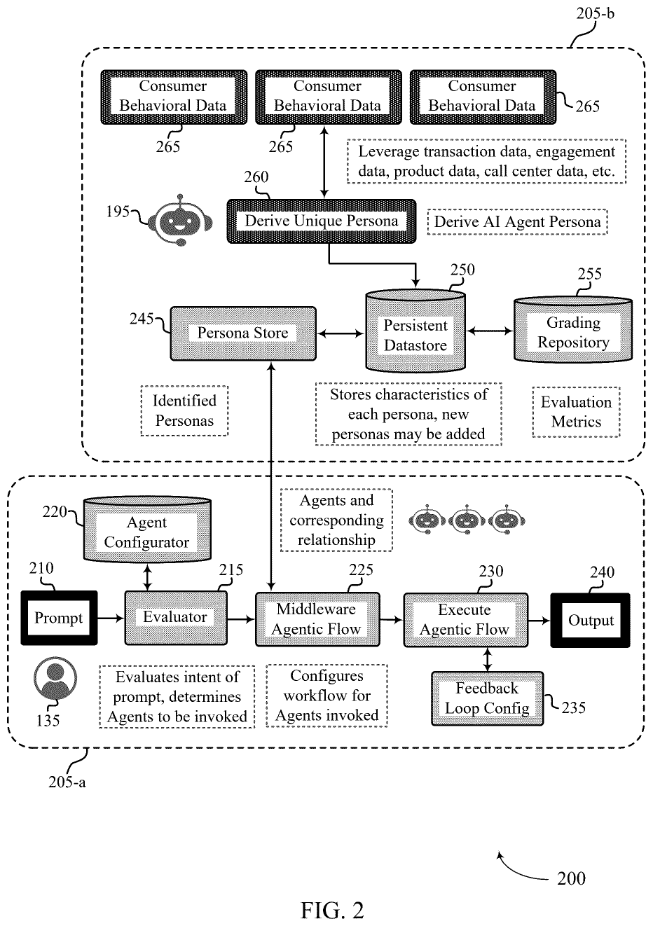

FIG. 2 shows an example of an AI agent configuration and execution framework 200 that supports generation and implementation of AI agent personas for task execution in accordance with aspects of the present disclosure. The AI agent configuration and execution framework may include a user 135 (which may be an example of a user 135 described with reference to FIG. 1) that may interact with an AI agent 195 (which may be an example of an AI agent 195 described with reference to FIG. 1) to identify and execute one or more tasks using a set of software agents or “AI agents.” For example, the user 135 may, via a user device, provide a prompt that invokes the generation or selection of one or more AI agents for various different purposes, such as for generation of content that is tailored to a specific group of people, or for employee training purposes, among other uses. In some aspects, the one or more AI agents may be generated or configured using generative AI (e.g., one or more LLMs, one or more generative pre-trained transformers (GPTs, and the like) to emulate one or more groups of people that have similar or shared characteristics (such as people who are of a certain age or generation, or people who have certain financial tendencies, among other characteristics).

During AI agent flow 205-a, an entity (such as a user 135 or an application) may submit a prompt 210 that includes information that initiates the AI agent configuration and execution framework 200. In some aspects, the prompt includes information as to what information is requested for generation (e.g., what kind of AI agents 195 should be generated or selected), one or more tasks that are requested for execution, a target population to emulate (e.g., what kind of person and/or people the one or more AI agents 195 should emulate). In some examples, the prompt may include parameters or desired outcomes of a task that the user 135 will utilize the one or more AI agents 195 to complete.

After submission of the prompt 210, the evaluator 215 may intercept the prompt 210 to identify the intent of the prompt 210 (e.g., what is the ask included in the prompt 210). In some examples, the prompt 210 may be a request for content generation by one or more AI agents 195 such as creating a tagline, a blog, an article, information targeted for a user interface, among other types of generated content. For example, an institution may invoke the use of an AI agent 195 that emulates the language and tendencies of a millennial in order to generate content tailored for millennial customers. Additionally, or alternatively, the evaluator 215 may identify the intent of the prompt 210 is to summarize one or more documents or articles (e.g., extract information from a document), to obtain an answer from a document, among other tasks. In some examples, the evaluator 215 may also identify the domain of the prompt 210 based on user parameter metadata or application metadata. For example, the evaluator 215 may determine that the prompt 210 is associated with various different lines of business (such as automotive, banking, credit risk, fraud, among other areas of business).

After the evaluator 215 evaluates the prompt 210, the evaluator 215 may refer to the agent configurator 220 to identify a quantity of AI agents 195 to be invoked (e.g., how many AI agents 195 are to be used) to execute the prompt 210, and the type of AI agents 195 to be invoked (e.g., the characteristics of the AI agents to be invoked). The agent configurator 220 may be a storage database (such as databases and other data storage implementations described with reference to FIG. 1) that includes a framework for different AI agent configurations, and includes a quantity of pre-determined AI agent configurations that may be available for selection by the evaluator 215. For example, the pre-determined AI agents configurations may be AI agents configurations generated based on initial testing (e.g., the AI agent configurations may be generated using one or more machine learning models or LLMs using one or more training datasets). Additionally, or alternatively, the agent configurator 220 may include one or more AI agent configurations that have been previously used for prior tasks, and stored in the agent configurator 220 by a user 135 or another application. In addition, if the evaluator 215 selects an AI agent configuration that is deemed to be insufficient for completing the task in the prompt, the agent configurator 220 may perform one or more configuration updates to reconfigure the AI agent configuration.

In some aspects, the evaluator 215 may receive a prompt 210 for which no matching AI agent configuration is present in the agent configurator 220. In some such cases, the evaluator 215 may assign a default configuration to the prompt 210, and may, after execution of the AI agent flow 205-a, match the process performed for the prompt 210 to an existing template, or may create a new template (e.g., if no matches exist for the process).

After the evaluator 215 identifies the quantity and characteristics of the AI agents 195 invoked for the prompt 210, the evaluator 215 may pass information to the middleware agentic flow 225 (e.g., the middleware agentic workflow). Based on the selected AI agent configuration, the middleware agentic flow 225 may obtain AI agent personas from the persona store 245, which may include various different personas associated with different AI agent configurations. For example, the different personas may include a “Gen-Z” persona, a “Millennial” persona, a “Boomer” persona (among other generational personas that emulate a person from a specific generation), a persona that emulates a reviewer-type personality or a critic-type personality, a persona that emulates a dissatisfied customer, among other possible personality characteristics of a target population. The middleware agentic flow 225 may obtain a list of relevant AI agents 195 and may configure the agents in a workflow at runtime. In examples in which a specific persona is unavailable (or is not present) in the persona store 245, the middleware agentic flow 225 may execute one or more algorithms (such as a K-nearest neighbor (KNN) or K-means algorithms) to determine a “nearest” match to a persona in the persona store 245. In some other examples, a specific persona may be generated and added to the persona store 245.

After the middleware agentic flow 225 identifies the AI agents 195, the relevant personas (and the relationship between the AI agents 195 and the relevant personas), the identified AI agents 195 may execute the agentic flow at 230 (e.g., relevant agents execute the flow). For example, an institution may use one or more AI agents 195 to train call-center employees to better handle dissatisfied (or otherwise challenging) customers. The institution may then create a prompt that generates one or more AI agents that emulate a challenging or dissatisfied customer, which may be used for training employees (e.g., an employee may interact with the AI agent(s) to practice efficient techniques for handling such a customer). Additionally, or alternatively, the institution may use one or more AI agents to create content or write different posts on a website or an application that are targeted to appeal to various different groups of people. For example, if an institution knows that a customer using an application is part of “Gen-Z,” then the institution may invoke the use of one or more AI agents that emulate a “Gen-Z” persona to tailor the application towards the customer. In such cases, the AI agent(s) may modify or utilize various techniques to enable such an application to be relatively more user-friendly or more appealing to such a demographic.

After executing the agentic flow at 230, the results of the executed flow may be subject to one or more grading mechanisms which may provide a grade for each output from the AI agent 195 that was generated or selected. In some aspects, the AI agent 195 may be graded using one or more evaluation metrics (e.g., thumbs up or thumbs down to indicate good or bad performance, a binary grading system, comments from the user may be used as a grade, and positive or negative comments may be quantified as a number or scale). After a grade for the AI agent 195 is generated, the grading data may be stored in a grading repository 255. In some aspects, the information stored in the grading repository 255 may be used to modify or improve AI agents 195 generated for future prompts (e.g., the grading data may be used as training data). In some aspects, the feedback loop configuration 235 may be used to apply feedback (e.g., results of the grading) to future flows. Additionally, or alternatively, the feedback loop configuration 235 may identify various aspects associated with flow execution, such as the number of times the flow was executed, among other efficiency metrics associated with flow execution.

A final output 240 may also be generated after execution of the agentic flow at 230. In some examples, the final output 240 may be graded (e.g., in addition to or separately from the grading of the AI agent configurations), and the grading results of the final output 240 may be stored in the grading repository 255.

The AI agent flow 205-b may perform various tasks to support execution of the AI agent flow 205-a. For example, the AI agent flow 205-b may generate and store various persona used in the AI agent flow 205-a. For example, various data may be ingested to derive various persona used in execution of the AI agent flow 205-a. In some implementations, the data may be consumer behavioral data 265, including demographic data, transaction data, customer engagement data (e.g., data gathered from customer surveys, events, or other customer interactions), call center data, and other customer data. Additionally, or alternatively, the consumer behavioral data 265 may include psychographic data (which may be derived from demographic and transaction data), including information about values, attitudes, interests, personality traits, or any combination thereof, of a customer.

The consumer behavioral data 265 may be utilized to generate a unique persona 260, which may be used as an AI agent 195. Some examples of the unique persona may include a single trait (such as a high net-worth person), or a combination of traits (such as a high net-worth, “super saver” Gen-Z or Millennial person). A multitude of different unique personas may be generated using the consumer behavioral data 265. Additionally, or alternatively, new personas may be manually configured and added (e.g., by a user 135). In some examples, the persona and corresponding characteristics and/or values may be stored in the persistent datastore 250.

In some aspects, the persistent datastore 250 may be in communication with the grading repository 255, which may store one or more evaluation metrics and results of previously executed flows. The persona grading system may evaluate the performance of each AI agent 195 within a generated persona, and may also evaluate the performance of the persona itself. In some examples, the result of grading for each execution may be stored in the grading repository 255, and the data stored in the grading repository 255 may be leveraged to modify (e.g., change, fine-tune) the characteristics of each generated persona to improve the final output 240.

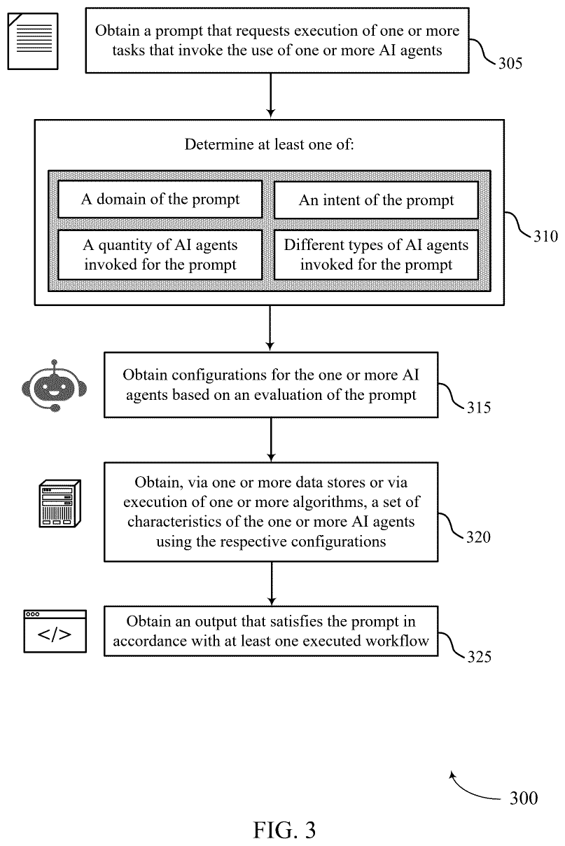

FIG. 3 shows an example of a process flow 300 that supports generation and implementation of AI agent personas for task execution in accordance with aspects of the present disclosure. Alternative examples of the following may be implemented. Some steps are performed in a different order than described herein, may be performed simultaneously (e.g., in parallel), or are not performed at all. In some implementations, steps may include additional features not mentioned below, or additional steps may be added. Further, the operations of the process flow 300, may be performed by one or more software functions, computing nodes, computing systems, or other aspects capable of supporting the techniques described herein.

At 305, an AI agent flow may obtain a prompt (e.g., from an external source, a user, or an application) that includes a request to execute one or more tasks that invoke use of one or more AI agents, where each AI agent of the one or more AI agents may be configured to exhibit one or more characteristics (e.g., based on personality traits, values, demographic data, application interaction data, geographic data, engagement data, behavioral data, psychographic data, or any combination thereof) of a user.

At 310, the AI agent flow may determine, in accordance with the request, at least one of an intent of the prompt, a domain of the prompt, a quantity of AI agents invoked for the prompt, or one or more different types of AI agents invoked for the prompt. In some examples, to determine the intent of the prompt, the AI agent flow may identify the request associated with the prompt, where the request may include a request for creation of content, summarization of content, user interaction with content, or any combination thereof. In some examples, the AI agent flow may determine the domain of the prompt using parameter information of the user, application metadata, or both. In some examples, the AI agent flow may determine the quantity of AI agents invoked for the prompt by obtaining a message (e.g., from an evaluator) that includes an indication of the quantity of agents invoked for the prompt.

At 315, the AI agent flow may obtain respective configurations of the one or more AI agents based on an evaluation of the prompt. In some examples, the AI agent flow may obtain the respective configurations by selecting the respective configurations of the one or more AI agents from a set of initial configurations, where the initial configurations may be based on (e.g., generated using) one or more training datasets. Additionally, or alternatively, the AI agent flow may obtain the respective configurations by selecting the respective configurations of the one or more AI agents from a set of configurations. In some cases, the AI agent flow may also obtain one or more updates to the respective configurations based on the respective configurations failing to satisfy an agent performance threshold for the one or more AI agents. In some examples, the AI agent flow may determine that a set of available configurations fail to satisfy the prompt, and may assign a default configuration to the prompt. In such examples, the AI agent flow may match the prompt to an existing process template after the prompt is completed, or may generate an additional (e.g., new) process template after the prompt is completed.

At 320, the AI agent flow may obtain, via one or more data stores or via execution of one or more algorithms, a set of characteristics of the one or more AI agents in accordance with the respective configurations. In some examples, the one or more algorithms may include a KNN algorithm, a k-means algorithm, a machine learning algorithm, or any combination thereof.

At 325, the AI agent flow may obtain one or more outputs that satisfy the prompt in accordance with at least one workflow executed by the one or more AI agents. In some cases, the AI agent flow may obtain an evaluation score (e.g., a grade) associated with the one or more outputs, with one or more AI agents, or both, where the evaluation score may be indicative of an effectiveness of the one or more AI agents in execution of the prompt. In some examples, the evaluation score may be stored in a database, and may include a binary evaluation that represents a positive evaluation (e.g., thumbs up, or a “1” value) or a negative evaluation (e.g., thumbs down, or a “0” value). In some other examples, the evaluation score may include a numerical score, a numerical percentage, one or more quantitative or qualitative metrics, or any combination thereof. In some aspects, the AI agent flow may apply feedback associated with the evaluation score in accordance with one or more feedback loops. For example, application of the feedback may include modifying or changing the one or more AI agents based on the feedback.

FIG. 4 shows a block diagram 400 of a system 405 that supports generation and implementation of AI agent personas for task execution in accordance with aspects of the present disclosure. In some examples, the system 405 may be an example of aspects of one or more components described with reference to FIG. 1, such as a DMS 110. The system 405 may include an input interface 410, an output interface 415, and an AI agent configuration and execution component 420. The system 405 may also include one or more processors. Each of these components may be in communication with one another (e.g., via one or more buses, communications links, communications interfaces, or any combination thereof).

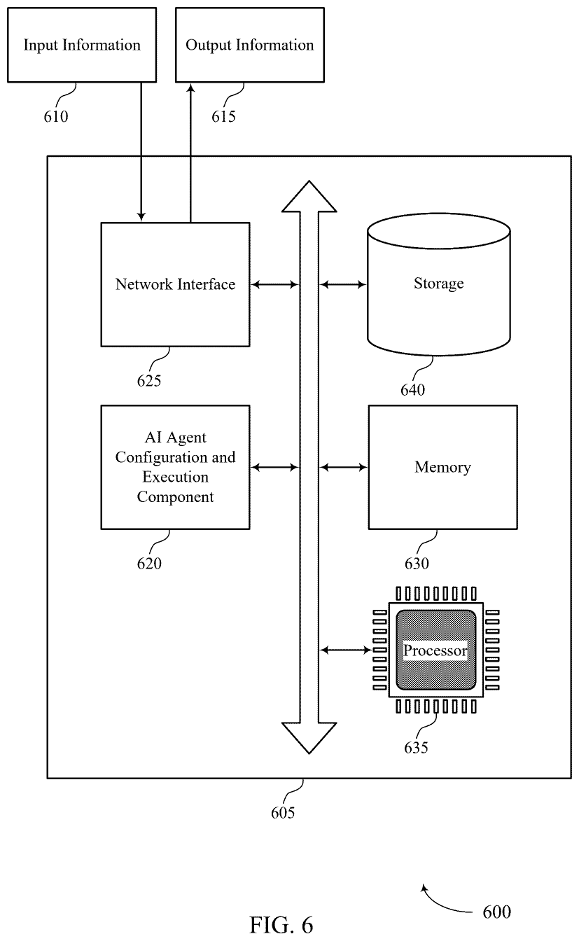

The input interface 410 may manage inputs for the system 405. For example, the input interface 410 may receive inputs (e.g., messages, packets, data, instructions, commands, or any other form of encoded information) from other systems or devices. The input interface 410 may produce outputs corresponding to (e.g., representative of or otherwise based on) such inputs to other components of the system 405 for processing. For example, the input interface 410 may output signaling to the AI agent configuration and execution component 420 to support generation and implementation of AI agent personas for task execution. In some cases, the input interface 410 may be a component of a network interface 625 as described with reference to FIG. 6.

The output interface 415 may manage output signaling for the system 405. For example, the output interface 415 may receive inputs from other components of the system 405, such as the AI agent configuration and execution component 420, and may produce outputs corresponding to (e.g., representative of or otherwise based on) such inputs to other systems or devices. In some cases, the output interface 415 may be a component of a network interface 625 as described with reference to FIG. 6.

For example, the AI agent configuration and execution component 420 may include a prompt evaluation component 425, an AI agent configuration component 430, a workflow evaluation component 435, or any combination thereof. In some examples, the AI agent configuration and execution component 420, or various components thereof, may be configured to perform various operations (e.g., receiving, monitoring, transmitting) using or otherwise in cooperation with the input interface 410, the output interface 415, or both. For example, the AI agent configuration and execution component 420 may receive information from the input interface 410, send information to the output interface 415, or be integrated in combination with the input interface 410, the output interface 415, or both to receive information, transmit information, or perform various other operations as described herein.

The prompt evaluation component 425 may be configured as or otherwise support a means for obtaining a prompt that includes a request to execute one or more tasks that invoke use of one or more AI agents, where each AI agent of the one or more AI agents are configured to exhibit one or more characteristics of a user. The prompt evaluation component 425 may be configured as or otherwise support a means for determining, in accordance with the request, at least one of an intent of the prompt, a domain of the prompt, a quantity of AI agents invoked for the prompt, or one or more different types of AI agents invoked for the prompt. The AI agent configuration component 430 may be configured as or otherwise support a means for obtaining respective configurations of the one or more AI agents based on an evaluation of the prompt. The AI agent configuration component 430 may be configured as or otherwise support a means for obtaining, via one or more data stores or via execution of one or more algorithms, a set of characteristics of the one or more AI agents in accordance with the respective configurations. The workflow evaluation component 435 may be configured as or otherwise support a means for obtaining one or more outputs that satisfy the prompt in accordance with at least one workflow executed by the one or more AI agents.

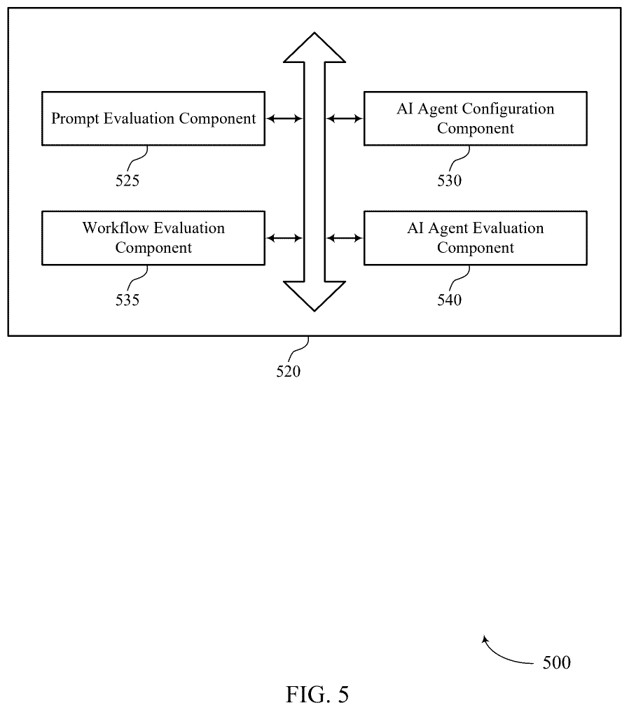

FIG. 5 shows a block diagram 500 of an AI agent configuration and execution component 520 that supports generation and implementation of AI agent personas for task execution in accordance with aspects of the present disclosure. The AI agent configuration and execution component 520 may be an example of aspects of an AI agent configuration and execution component or an AI agent configuration and execution component 420, or both, as described herein. The AI agent configuration and execution component 520, or various components thereof, may be an example of means for performing various aspects of generation and implementation of AI agent personas for task execution as described herein. For example, the AI agent configuration and execution component 520 may include a prompt evaluation component 525, an AI agent configuration component 530, a workflow evaluation component 535, an AI agent evaluation component 540, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The prompt evaluation component 525 may be configured as or otherwise support a means for obtaining a prompt that includes a request to execute one or more tasks that invoke use of one or more AI agents, where each AI agent of the one or more AI agents are configured to exhibit one or more characteristics of a user. In some examples, the prompt evaluation component 525 may be configured as or otherwise support a means for determining, in accordance with the request, at least one of an intent of the prompt, a domain of the prompt, a quantity of AI agents invoked for the prompt, or one or more different types of AI agents invoked for the prompt. The AI agent configuration component 530 may be configured as or otherwise support a means for obtaining respective configurations of the one or more AI agents based on an evaluation of the prompt. In some examples, the AI agent configuration component 530 may be configured as or otherwise support a means for obtaining, via one or more data stores or via execution of one or more algorithms, a set of characteristics of the one or more AI agents in accordance with the respective configurations. The workflow evaluation component 535 may be configured as or otherwise support a means for obtaining one or more outputs that satisfy the prompt in accordance with at least one workflow executed by the one or more AI agents.

In some examples, the AI agent evaluation component 540 may be configured as or otherwise support a means for obtaining an evaluation score associated with the one or more outputs, where the evaluation score is indicative of an effectiveness of the one or more AI agents in execution of the prompt.

In some examples, the AI agent evaluation component 540 may be configured as or otherwise support a means for storing the evaluation score in a database, where the evaluation score includes a binary evaluation representative of a positive evaluation, a negative evaluation, a numerical score, a numerical percentage, one or more quantitative metrics, or any combination thereof. In some examples, the AI agent evaluation component 540 may be configured as or otherwise support a means for applying feedback associated with the evaluation score in accordance with one or more feedback loops, where application of the feedback includes modifying the one or more AI agents based on the feedback.

In some examples, to support determining the intent of the prompt, the prompt evaluation component 525 may be configured as or otherwise support a means for identifying the request associated with the prompt, where the request includes creation of content, summarization of content, evaluation of content, interaction with content, or any combination thereof. In some examples, to support determining the domain of the prompt, the prompt evaluation component 525 may be configured as or otherwise support a means for determining the domain of the prompt based on parameter information of the user, application metadata, or both.

In some examples, to support determining the quantity of AI agents invoked for the prompt, the prompt evaluation component 525 may be configured as or otherwise support a means for obtaining a message including an indication of the quantity of AI agents invoked for the prompt, determining the quantity of AI agents is based on obtaining the indication. In some examples, to support obtaining the respective configurations of the one or more AI agents, the AI agent configuration component 530 may be configured as or otherwise support a means for selecting the respective configurations of the one or more AI agents from a set of initial configurations, where the set of initial configurations are based on one or more training datasets.

In some examples, to support obtaining the respective configurations of the one or more AI agents, the AI agent configuration component 530 may be configured as or otherwise support a means for selecting the respective configurations of the one or more AI agents from a set of configurations. In some examples, to support obtaining the respective configurations of the one or more AI agents, the AI agent configuration component 530 may be configured as or otherwise support a means for obtaining one or more updates to the respective configurations based on the respective configurations failing to satisfy an agent performance threshold for the one or more AI agents.

In some examples, the AI agent configuration component 530 may be configured as or otherwise support a means for determining that a set of available configurations fail to satisfy the prompt. In some examples, to obtain the respective configurations of the one or more AI agents, the AI agent configuration component 530 may be configured as or otherwise support a means for assigning a default configuration to the prompt, where obtaining the one or more outputs satisfying the prompt is based on the default configuration.

In some examples, the AI agent configuration component 530 may be configured as or otherwise support a means for matching the prompt to an existing process template after the prompt is completed. In some examples, the AI agent configuration component 530 may be configured as or otherwise support a means for generating an additional process template after the prompt is completed. In some examples, the set of characteristics of the one or more AI agents are based on demographic data, geographic data, application interaction data, engagement data, behavioral data, psychographic data, or any combination thereof.

In some examples, the one or more algorithms include a KNN algorithm, a k-means algorithm, a machine learning algorithm, or any combination thereof. In some examples, the prompt may be submitted by at least one of an external source, the user, or an application.

FIG. 6 shows a block diagram 600 of a system 605 that supports generation and implementation of AI agent personas for task execution in accordance with aspects of the present disclosure. The system 605 may be an example of or include components of a system 405 as described herein. The system 605 may include components for data management, including components such as an AI agent configuration and execution component 620, an input information 610, an output information 615, a network interface 625, at least one memory 630, at least one processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting generation and implementation of AI agent personas for task execution). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

For example, the AI agent configuration and execution component 620 may be configured as or otherwise support a means for obtaining a prompt that includes a request to execute one or more tasks that invoke use of one or more AI agents, where each AI agent of the one or more AI agents are configured to exhibit one or more characteristics of a user. The AI agent configuration and execution component 620 may be configured as or otherwise support a means for determining, in accordance with the request, at least one of an intent of the prompt, a domain of the prompt, a quantity of AI agents invoked for the prompt, or one or more different types of AI agents invoked for the prompt. The AI agent configuration and execution component 620 may be configured as or otherwise support a means for obtaining respective configurations of the one or more AI agents based on an evaluation of the prompt. The AI agent configuration and execution component 620 may be configured as or otherwise support a means for obtaining, via one or more data stores or via execution of one or more algorithms, a set of characteristics of the one or more AI agents in accordance with the respective configurations. The AI agent configuration and execution component 620 may be configured as or otherwise support a means for obtaining one or more outputs that satisfy the prompt in accordance with at least one workflow executed by the one or more AI agents.

By including or configuring the AI agent configuration and execution component 620 in accordance with examples as described herein, the system 605 may support techniques for generation and implementation of AI agent personas for task execution, which may provide one or more benefits such as, for example, improved user experience based on use of personalized AI agents, more efficient utilization of computing resources, network resources or both, improved scalability, improved training for employees of an organization, increased content generation efficiency, improved tailoring of content to different demographics, among other possibilities.

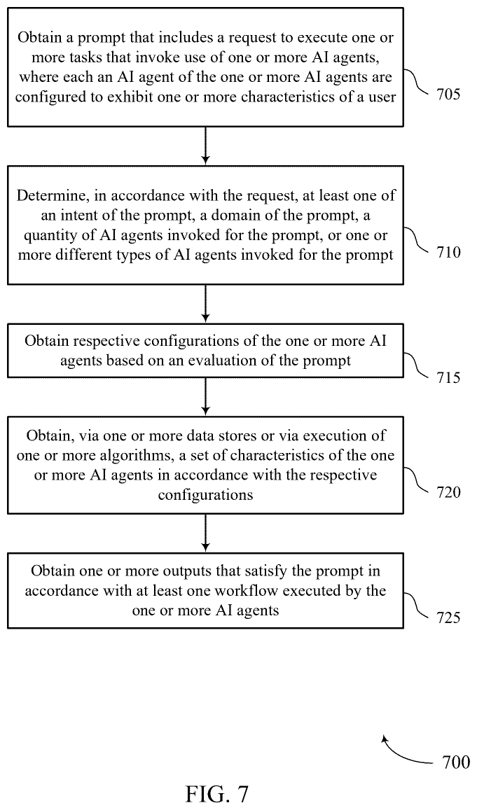

FIG. 7 shows a flowchart illustrating a method 700 that supports generation and implementation of AI agent personas for task execution in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include obtaining a prompt that includes a request to execute one or more tasks that invoke use of one or more AI agents, where each AI agent of the one or more AI agents are configured to exhibit one or more characteristics of a user. The operations of 705 may be performed in accordance with examples as disclosed herein. In some examples, aspects of the operations of 705 may be performed by a prompt evaluation component 525 as described with reference to FIG. 5.

At 710, the method may include determining, in accordance with the request, at least one of an intent of the prompt, a domain of the prompt, a quantity of AI agents invoked for the prompt, or one or more different types of AI agents invoked for the prompt. The operations of 710 may be performed in accordance with examples as disclosed herein. In some examples, aspects of the operations of 710 may be performed by a prompt evaluation component 525 as described with reference to FIG. 5.

At 715, the method may include obtaining respective configurations of the one or more AI agents based on an evaluation of the prompt. The operations of 715 may be performed in accordance with examples as disclosed herein. In some examples, aspects of the operations of 715 may be performed by an AI agent configuration component 530 as described with reference to FIG. 5.

At 720, the method may include obtaining, via one or more data stores or via execution of one or more algorithms, a set of characteristics of the one or more AI agents in accordance with the respective configurations. The operations of 720 may be performed in accordance with examples as disclosed herein. In some examples, aspects of the operations of 720 may be performed by an AI agent configuration component 530 as described with reference to FIG. 5.

At 725, the method may include obtaining one or more outputs that satisfy the prompt in accordance with at least one workflow executed by the one or more AI agents. The operations of 725 may be performed in accordance with examples as disclosed herein. In some examples, aspects of the operations of 725 may be performed by a workflow evaluation component 535 as described with reference to FIG. 5.

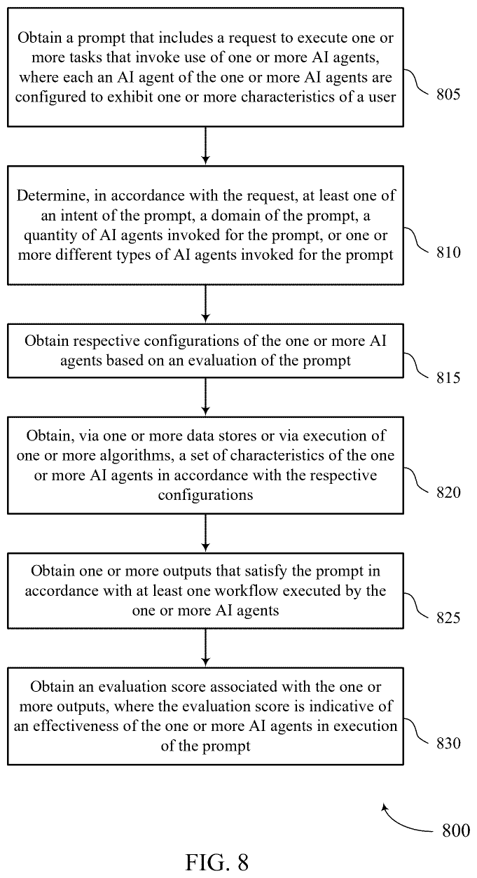

FIG. 8 shows a flowchart illustrating a method 800 that supports generation and implementation of AI agent personas for task execution in accordance with aspects of the present disclosure. The operations of the method 800 may be implemented by a DMS or its components as described herein. For example, the operations of the method 800 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 805, the method may include obtaining a prompt that includes a request to execute one or more tasks that invoke use of one or more AI agents, where each AI agent of the one or more AI agents are configured to exhibit one or more characteristics of a user. The operations of 805 may be performed in accordance with examples as disclosed herein. In some examples, aspects of the operations of 805 may be performed by a prompt evaluation component 525 as described with reference to FIG. 5.

At 810, the method may include determining, in accordance with the request, at least one of an intent of the prompt, a domain of the prompt, a quantity of AI agents invoked for the prompt, or one or more different types of AI agents invoked for the prompt. The operations of 810 may be performed in accordance with examples as disclosed herein. In some examples, aspects of the operations of 810 may be performed by a prompt evaluation component 525 as described with reference to FIG. 5.

At 815, the method may include obtaining respective configurations of the one or more AI agents based on an evaluation of the prompt. The operations of 815 may be performed in accordance with examples as disclosed herein. In some examples, aspects of the operations of 815 may be performed by an AI agent configuration component 530 as described with reference to FIG. 5.

At 820, the method may include obtaining, via one or more data stores or via execution of one or more algorithms, a set of characteristics of the one or more AI agents in accordance with the respective configurations. The operations of 820 may be performed in accordance with examples as disclosed herein. In some examples, aspects of the operations of 820 may be performed by an AI agent configuration component 530 as described with reference to FIG. 5.

At 825, the method may include obtaining one or more outputs that satisfy the prompt in accordance with at least one workflow executed by the one or more AI agents. The operations of 825 may be performed in accordance with examples as disclosed herein. In some examples, aspects of the operations of 825 may be performed by a workflow evaluation component 535 as described with reference to FIG. 5.

At 830, the method may include obtaining an evaluation score associated with the one or more outputs, where the evaluation score is indicative of an effectiveness of the one or more AI agents in execution of the prompt. The operations of 830 may be performed in accordance with examples as disclosed herein. In some examples, aspects of the operations of 830 may be performed by an AI agent evaluation component 540 as described with reference to FIG. 5.

The following provides an overview of aspects of the present disclosure:
Aspect 1: A method, comprising: obtaining a prompt that includes a request to execute one or more tasks that invoke use of one or more AI agents, wherein each AI agent of the one or more AI agents are configured to exhibit one or more characteristics of a user; determining, in accordance with the request, at least one of an intent of the prompt, a domain of the prompt, a quantity of AI agents invoked for the prompt, or one or more different types of AI agents invoked for the prompt; obtaining respective configurations of the one or more AI agents based at least in part on an evaluation of the prompt; obtaining, via one or more data stores or via execution of one or more algorithms, a set of characteristics of the one or more AI agents in accordance with the respective configurations; and obtaining one or more outputs that satisfy the prompt in accordance with at least one workflow executed by the one or more AI agents.
Aspect 2: The method of aspect 1, further comprising: obtaining an evaluation score associated with the one or more outputs, wherein the evaluation score is indicative of an effectiveness of the one or more AI agents in execution of the prompt.
Aspect 3: The method of aspect 2, further comprising: storing the evaluation score in a database, wherein the evaluation score comprises a binary evaluation representative of a positive evaluation, a negative evaluation, a numerical score, a numerical percentage, one or more quantitative metrics, or any combination thereof.
Aspect 4: The method of any of aspects 2 through 3, further comprising: applying feedback associated with the evaluation score in accordance with one or more feedback loops, wherein application of the feedback comprises modifying the one or more AI agents based at least in part on the feedback.
Aspect 5: The method of any of aspects 1 through 4, wherein determining the intent of the prompt comprises: identifying the request associated with the prompt, wherein the request comprises creation of content, summarization of content, evaluation of content, interaction with content, or any combination thereof.
Aspect 6: The method of any of aspects 1 through 5, wherein determining the domain of the prompt comprises: determining the domain of the prompt based at least in part on parameter information of the user, application metadata, or both.
Aspect 7: The method of any of aspects 1 through 6, wherein determining the quantity of AI agents invoked for the prompt comprises: obtaining a message comprising an indication of the quantity of AI agents invoked for the prompt, determining the quantity of AI agents is based at least in part on obtaining the indication.
Aspect 8: The method of any of aspects 1 through 7, wherein obtaining the respective configurations of the one or more AI agents comprises: selecting the respective configurations of the one or more AI agents from a set of initial configurations, wherein the set of initial configurations are based at least in part on one or more training datasets.
Aspect 9: The method of any of aspects 1 through 8, wherein obtaining the respective configurations of the one or more AI agents comprises: selecting the respective configurations of the one or more AI agents from a set of configurations; and obtaining one or more updates to the respective configurations based at least in part on the respective configurations failing to satisfy an agent performance threshold for the one or more AI agents.
Aspect 10: The method of any of aspects 1 through 9, further comprising: determining that a set of available configurations fail to satisfy the prompt, wherein obtaining the respective configurations of the one or more AI agents comprises: assigning a default configuration to the prompt, wherein obtaining the one or more outputs satisfying the prompt is based at least in part on the default configuration.
Aspect 11: The method of aspect 10, further comprising: matching the prompt to an existing process template after the prompt is completed; or generating an additional process template after the prompt is completed.
Aspect 12: The method of any of aspects 1 through 11, wherein the set of characteristics of the one or more AI agents are based at least in part on demographic data, geographic data, application interaction data, engagement data, behavioral data, psychographic data, or any combination thereof.
Aspect 13: The method of any of aspects 1 through 12, wherein the one or more algorithms comprise a k-nearest neighbors (KNN) algorithm, a k-means algorithm, a machine learning algorithm, or any combination thereof.
Aspect 14: The method of any of aspects 1 through 13, wherein the prompt is submitted by at least one of an external source, the user, or an application.
Aspect 15: An apparatus comprising one or more memories storing processor-executable code, and one or more processors coupled with the one or more memories and individually or collectively operable to execute the code to cause the apparatus to perform a method of any of aspects 1 through 14.
Aspect 16: An apparatus comprising at least one means for performing a method of any of aspects 1 through 14.
Aspect 17: A non-transitory computer-readable medium storing code the code comprising instructions executable by one or more processors to perform a method of any of aspects 1 through 14.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
obtaining a prompt that includes a request to execute one or more tasks that invoke use of one or more artificial intelligence (AI) agents, wherein each AI agent of the one or more AI agents are configured to exhibit one or more characteristics of a user;
determining, in accordance with the request, at least one of an intent of the prompt, a domain of the prompt, a quantity of AI agents invoked for the prompt, or one or more different types of AI agents invoked for the prompt;
obtaining respective configurations of the one or more AI agents based at least in part on an evaluation of the prompt;
obtaining, via one or more data stores or via execution of one or more algorithms, a set of characteristics of the one or more AI agents in accordance with the respective configurations; and
obtaining one or more outputs that satisfy the prompt in accordance with at least one workflow executed by the one or more AI agents.

2. The method of claim 1, further comprising:
obtaining an evaluation score associated with the one or more outputs, wherein the evaluation score is indicative of an effectiveness of the one or more AI agents in execution of the prompt.

3. The method of claim 2, further comprising:
storing the evaluation score in a database, wherein the evaluation score comprises a binary evaluation representative of a positive evaluation, a negative evaluation, a numerical score, a numerical percentage, one or more quantitative metrics, or any combination thereof.

4. The method of claim 2, further comprising:
applying feedback associated with the evaluation score in accordance with one or more feedback loops, wherein application of the feedback comprises modifying the one or more AI agents based at least in part on the feedback.

5. The method of claim 1, wherein determining the intent of the prompt comprises:
identifying the request associated with the prompt, wherein the request comprises creation of content, summarization of content, evaluation of content, interaction with content, or any combination thereof.

6. The method of claim 1, wherein determining the domain of the prompt comprises:
determining the domain of the prompt based at least in part on parameter information of the user, application metadata, or both.

7. The method of claim 1, wherein determining the quantity of AI agents invoked for the prompt comprises:
obtaining a message comprising an indication of the quantity of AI agents invoked for the prompt, determining the quantity of AI agents is based at least in part on obtaining the indication.

8. The method of claim 1, wherein obtaining the respective configurations of the one or more AI agents comprises:
selecting the respective configurations of the one or more AI agents from a set of initial configurations, wherein the set of initial configurations are based at least in part on one or more training datasets.

9. The method of claim 1, wherein obtaining the respective configurations of the one or more AI agents comprises:
selecting the respective configurations of the one or more AI agents from a set of configurations; and
obtaining one or more updates to the respective configurations based at least in part on the respective configurations failing to satisfy an agent performance threshold for the one or more AI agents.

10. The method of claim 1, further comprising:
determining that a set of available configurations fail to satisfy the prompt, wherein obtaining the respective configurations of the one or more AI agents comprises:
assigning a default configuration to the prompt, wherein obtaining the one or more outputs satisfying the prompt is based at least in part on the default configuration.

11. The method of claim 10, further comprising:
matching the prompt to an existing process template after the prompt is completed; or
generating an additional process template after the prompt is completed.

12. The method of claim 1, wherein the set of characteristics of the one or more AI agents are based at least in part on demographic data, geographic data, application interaction data, engagement data, behavioral data, psychographic data, or any combination thereof.

13. The method of claim 1, wherein the one or more algorithms comprise a k-nearest neighbors (KNN) algorithm, a k-means algorithm, a machine learning algorithm, or any combination thereof.

14. The method of claim 1, wherein the prompt is submitted by at least one of an external source, the user, or an application.

15. An apparatus, comprising:
one or more memories storing processor-executable code; and
one or more processors coupled with the one or more memories and individually or collectively operable to execute the code to cause the apparatus to:
obtain a prompt that includes a request to execute one or more tasks that invoke use of one or more artificial intelligence (AI) agents, wherein each AI agent of the one or more AI agents are configured to exhibit one or more characteristics of a user;
determine, in accordance with the request, at least one of an intent of the prompt, a domain of the prompt, a quantity of AI agents invoked for the prompt, or one or more different types of AI agents invoked for the prompt;
obtain respective configurations of the one or more AI agents based at least in part on an evaluation of the prompt;
obtain, via one or more data stores or via execution of one or more algorithms, a set of characteristics of the one or more AI agents in accordance with the respective configurations; and
obtain one or more outputs that satisfy the prompt in accordance with at least one workflow executed by the one or more AI agents.

16. The apparatus of claim 15, wherein the one or more processors are individually or collectively further operable to execute the code to cause the apparatus to:
obtain an evaluation score associated with the one or more outputs, wherein the evaluation score is indicative of an effectiveness of the one or more AI agents in execution of the prompt.

17. The apparatus of claim 16, wherein the one or more processors are individually or collectively further operable to execute the code to cause the apparatus to:
store the evaluation score in a database, wherein the evaluation score comprises a binary evaluation representative of a positive evaluation, a negative evaluation, a numerical score, a numerical percentage, one or more quantitative metrics, or any combination thereof.

18. The apparatus of claim 16, wherein the one or more processors are individually or collectively further operable to execute the code to cause the apparatus to:
apply feedback associated with the evaluation score in accordance with one or more feedback loops, wherein application of the feedback comprises modifying the one or more AI agents based at least in part on the feedback.

19. The apparatus of claim 15, wherein, to determine the intent of the prompt, the one or more processors are individually or collectively operable to execute the code to cause the apparatus to:
identify the request associated with the prompt, wherein the request comprises creation of content, summarization of content, evaluation of content, interaction with content, or any combination thereof.

20. A non-transitory computer-readable medium storing code, the code comprising instructions executable by one or more processors to:
obtain a prompt that includes a request to execute one or more tasks that invoke use of one or more artificial intelligence (AI) agents, wherein each AI agent of the one or more AI agents are configured to exhibit one or more characteristics of a user;
determine, in accordance with the request, at least one of an intent of the prompt, a domain of the prompt, a quantity of AI agents invoked for the prompt, or one or more different types of AI agents invoked for the prompt;
obtain respective configurations of the one or more AI agents based at least in part on an evaluation of the prompt;
obtain, via one or more data stores or via execution of one or more algorithms, a set of characteristics of the one or more AI agents in accordance with the respective configurations; and
obtain one or more outputs that satisfy the prompt in accordance with at least one workflow executed by the one or more AI agents.
